(19) United States
(12) Patent Application Publication
(10) Pub. No.: US 2008/0170030 A1
(43) Pub. Date: Jul. 17, 2008

(54) Image processing apparatus

(75) Inventor: Hiroshi Oshige, Matsumoto-shi (JP)

Correspondence Address: Edwards Angell Palmer & Dodge LLP, P.O.Box 55874, Boston, MA, 02205, US

(73) Assignee: Seiko Epson Corporation, Tokyo (JP)

(21) Appl. No.: 12/008,931

(22) Filed: Jan. 15, 2008

(30) Foreign Application Priority Data
Jan. 16, 2007 (JP) 2007-006999

(51) Int. Cl. G09G 3/36; G06K 9/00

(52) U.S. Cl. 345/102; 382/169

(57) ABSTRACT

An image processing apparatus includes a first display image data generation unit which acquires image data and generates first display image data including information about a plurality of pixels, a histogram generation unit which generates a histogram showing luminance distribution of the pixels contained in the first display image data, a second display image data generation unit which generates second display image data by taking a domain corresponding to a predetermined percent with high luminance among the entire luminance distribution area as a cutoff domain in the histogram generated by the histogram generation unit, setting up the luminance of the pixels in the cutoff domain to 100%, and changing the luminance of the pixels whose luminance is in a range from 0% to a cutoff luminance value which is a minimum luminance of the pixels in the cutoff domain to be 0 to 100% while maintaining the luminance distribution, an image display unit which has a backlight and displays an image on the basis of the second display image data, and a backlight setting change unit which changes a setup of the light quantity of the backlight on the basis of the cutoff luminance value.

The entire disclosure of Japanese Patent Application No. 2007-006999, filed Jan. 16, 2007 is expressly incorporated by reference herein.

### BACKGROUND

1. Technical Field

The present invention relates to an image processing apparatus which aims at reduction of power consumption by a backlight.

2. Related Art

Liquid crystal display units, each consisting of a liquid crystal display and a backlight, are widely used for notebook computers or portable small information terminals. These liquid crystal display units are aiming at improvement in user's visibility by irradiating the liquid crystal displays by backlights from rear sides thereof while an image is displayed on the liquid crystal displays.

The light quantity of the backlight can be adjusted by a user. For example, a user who likes a bright screen has set up the light quantity of the backlight high, but conversely a user who likes a dark screen has set up the light quantity of the backlight low.

Moreover, the notebook computers or the portable small information terminals are supposed to have a use mode in which they are driven only by a battery, and the power consumption of the backlight has big influence on drive time of the battery in such use mode. If the backlight is set up brightly, the drive time by the battery becomes short, and thus the user may make a setup of the backlight darkly at the sacrifice of the visibility of a screen.

This problem that users bear such inconvenience by force in this way arises not only with the notebook computers and portable small information terminals but also with general image processing apparatuses equipped with the backlights such as the image display units.

For this reason, JP-A-11-109317 discloses an image processing apparatus which aims at reduction of power consumption by a backlight without changing user's visual impression with respect to a display image by lowering the light quantity of the backlight while raising the luminance value of the display image. However, the image processing apparatus disclosed in JP-A-11-109317 has a problem of the increased cost by necessarily employing a specific circuit for generating a display image having enhanced luminance.

### SUMMARY

An advantage of some aspects of the invention is that it provides an image processing apparatus which aims at reduction of power consumption by a backlight and suppression of the cost increase by lowering the light quantity of the backlight while maintaining impression of a display image.

According to one aspect of the invention, there is provided an image processing apparatus including a first display image data generation unit which acquires image data and generates first display image data including information about a plurality of pixels, a histogram generation unit which generates a histogram showing luminance distribution of the pixels contained in the first display image data, a second display image data generation unit which generates second display image data by taking a domain corresponding to a predetermined percent with high luminance among the entire luminance distribution area as a cutoff domain in the histogram generated by the histogram generation unit, setting up the luminance of the pixels in the cutoff domain to 100%, and changing the luminance of the pixels whose luminance is in a range from 0% to a cutoff luminance value which is a minimum luminance of the pixels in the cutoff domain to be 0 to 100% while maintaining the luminance distribution, an image display unit which has a backlight and displays an image on the basis of the second display image data, and a backlight setting change unit which changes a setup of the light quantity of the backlight on the basis of the cutoff luminance value.

In the image processing apparatus, it is preferable that an image based on the first display image data is displayed on the image display unit.

In the image processing apparatus, it is preferable that the histogram generation unit generates the histogram of the pixels contained in the first display image data so that a brightest luminance and a darkest luminance are set up to 100% and 0%, respectively.

In the image processing apparatus, it is preferable that the second display image data generation unit changes the luminance of each of the pixels whose luminance is in a ranged from 0% to the cutoff luminance value to a value calculated by a formula: a luminance×100%/the cutoff luminance value.

In the image processing apparatus, it is preferable that the backlight setting change unit changes the setup of the light quantity of the backlight so as to be decreased from a preset value which is set as the light quantity of the backlight by a value corresponding the calculation result of a formula: 100%−the cutoff luminance value.

In the image processing apparatus, it is preferable that the image data is image data of a still image.

According to another aspect of the invention, there is provided a controlling method of an image processing apparatus including generating a first display image data including information about a plurality of pixels by acquiring image data, generating a histogram showing luminance distribution of the pixels contained in the first display image data, generating a second display image data by taking a domain corresponding to a predetermined percent with high luminance among the entire luminance distribution area as a cutoff domain in the generated histogram, setting up the luminance of the pixels in the cutoff domain to 100%, and changing the luminance of the pixels whose luminance is in a range from 0% to a cutoff luminance value which is a minimum luminance of the pixels in the cutoff domain to be 0 to 100% while maintaining the luminance distribution, displaying an image based on the second display image data on an image display unit having a backlight, and changing a setup of the light quantity of the backlight on the basis of the cutoff luminance value.

According to a further aspect of the invention there is provided a program to be executed by an image processing apparatus for carrying a processing including generating a first display image data including information about a plurality of pixels by acquiring image data, generating a histogram showing luminance distribution of the pixels contained in the first display image data, generating a second display image data by taking a domain corresponding to a predetermined percent with high luminance among the entire luminance distribution area as a cutoff domain in the generated histogram, setting up the luminance of the pixels in the cutoff domain to 100%, and changing the luminance of the pixels whose luminance is in a range from 0% to a cutoff luminance value which is a minimum luminance of the pixels in the cutoff domain to be 0 to 100% while maintaining the luminance distribution, displaying an image based on the second display image data on an image display unit having a backlight, and changing a setup of the light quantity of the backlight on the basis of the cutoff luminance value.

### BRIEF DESCRIPTION OF THE DRAWINGS

The invention will be described with reference to the accompanying drawings, wherein like numbers reference like elements.

FIG. 1 is a block diagram illustrating an internal structure of an image processing apparatus according to one embodiment of the invention.

FIG. 2 is a conceptual view illustrating the relationship between a first image storage region and a second image storage region in a memory and a liquid crystal display unit.

FIG. 3 is a flow chart explaining the contents of image display processing performed by the image processing apparatus shown in FIG. 1.

FIG. 4 is a view illustrating an exemplary image displayed on a liquid display unit shown in FIG. 1.

FIG. 5 is a view illustrating an exemplary histogram of an image displayed on a liquid crystal display unit.

FIG. 6 is an exemplary histogram of a display image changed by the image display processing shown in FIG. 3.

### DESCRIPTION OF EXEMPLARY EMBODIMENTS

Hereinafter, embodiments of the invention will be described with reference to the accompanying drawings. In addition, the embodiments explained below do not limit the technical range of the invention.

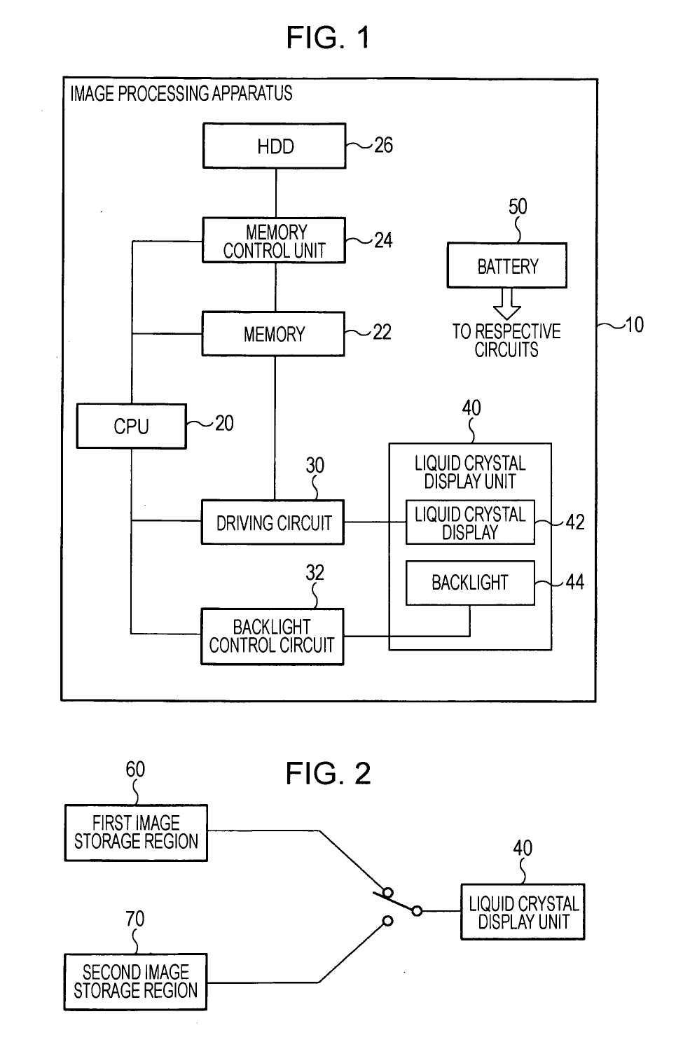

FIG. 1 is a block diagram showing an example of the overall internal structure of an image processing apparatus 10 according to one embodiment. As shown in FIG. 1, the image processing apparatus 10 according to this embodiment includes a Central Processing Unit (CPU) 20, a memory 22, a memory control unit 24, a hard disk drive 26, a liquid crystal display drive circuit 30, a backlight control circuit 32, a liquid crystal display unit 40, and a battery 50. Moreover, the liquid crystal display unit 40 is equipped with a liquid crystal display 42 and a backlight 44.

The CPU 20 is a unit for performing various kinds of control of the image processing apparatus 10. In this embodiment, the CPU 20 performs processing of generating display image data on the basis of image data of a still image which is read from the hard disk drive 26 and displaying an image based on the display image data on the liquid crystal display unit 40. The memory 22 is constituted by a Random Access Memory (RAM) and temporarily stores data and programs which are needed when the CPU 22 performs various kinds of processing.

The memory control unit 24 performs control for reading data or programs from a hard disk drive 26 and loading the data or the program into the memory 22. The memory control unit 24 is constituted by a Direct Memory Access (DMA) controller. That is, the memory control unit 24 is driven on the basis of instructions from the CPU 20, and the data or programs specified by the CPU 20 are read from the hard disk drive 26 under the control of the memory control unit 24 and then stored in the memory 22.

By the instructions from the CPU 20, the liquid crystal display drive circuit 30 acquires display image data from the memory 22, drives the liquid crystal display 42, and displays an image on the liquid crystal display 42. In this embodiment, the liquid crystal display 42 is structured in a manner such that a liquid crystal layer and a polarizing plate are interposed between two transparent substrates. Thus, a predetermined image is displayed on the liquid crystal display 42 by individually controlling and driving a plurality of transistors arranged in a matrix by the liquid crystal display drive circuit 30 and applying a voltage to the liquid crystal layer. In this embodiment, a color filter is disposed between two transparent substrates, and thus a color image is displayed on the liquid crystal display unit 40. Furthermore, the backlight 44 is arranged at the backside of the liquid crystal display 42, so improvement in the visibility of the image formed in the liquid crystal display 42 is achieved.

The backlight control circuit 32 drives the backlight 44 on the basis of the instructions from the CPU 20. That is, the backlight control circuit 32 increases or decreases the light quantity of the backlight 44 by controlling the voltage applied to the backlight 44 while switching on or off the backlight on the basis of the instructions from the CPU 20. Generally, if the light quantity of the backlight 44 increases, the user's visibility over the image displayed on the liquid crystal display 42 improves.

The battery 50 supplies power to every component in the image processing apparatus 10. The battery 50 is constituted by secondary batteries that are rechargeable. In addition, the image processing apparatus 10 in this embodiment is structured such that it can be driven also with AC power acquired from an electric socket (AC power source) in a home, and thus the battery 50 is recharged by the AC power supplied from the AC power source.

FIG. 2 is a view for notionally explaining a mechanism which displays an image on the liquid crystal display unit 40 in the image processing apparatus 10 according to this embodiment. As shown in this FIG. 2, in the image processing apparatus 10 according to this embodiment, the first image storage region 60 and the second image storage region 70 are provided in the memory 22. The first image storage region 60 and the second image storage region 70 are data storage regions called Video Random Access Memory (VRAM).

For example, while the image is displayed on the liquid crystal display unit 40 on the basis of the display image data developed in the first image storage region 60, the display image based on the following image data is developed and stored in the second image storage region 70. Then, when displaying the following image on the liquid crystal display unit 40, the liquid crystal display drive circuit 30 displays an image on the liquid crystal display unit 40 on the basis of the display image data developed in the second image storage region 70. Thanks to such operation, it is possible to quicken the image change in the liquid crystal display unit 40. In this embodiment, the drive circuit 30 switches the display image data stored in the first image storage region 60 and the display image data stored in the second image storage region 70 by turns at intervals of 33 ms and outputs the display image to the liquid crystal display unit 40. That is, one frame of the liquid crystal display unit 40 in this embodiment is 33 ms.

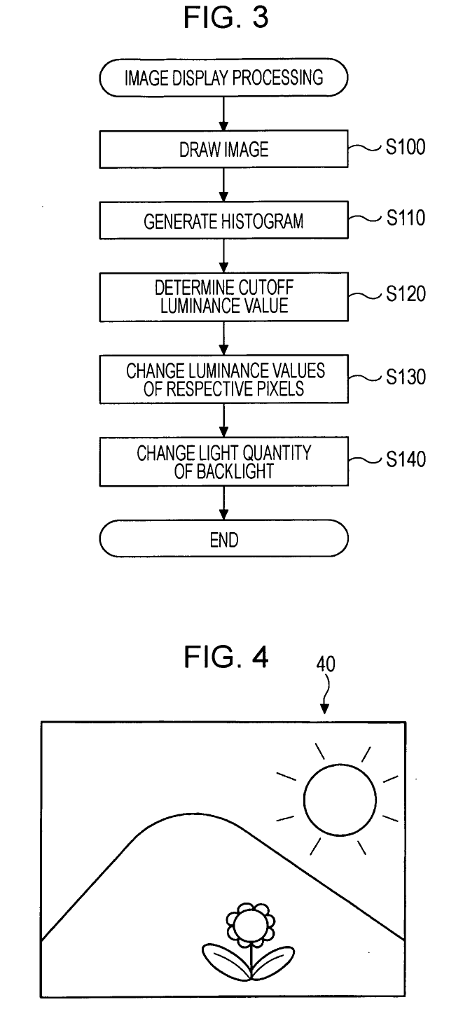

Hereinafter, an image processing method performed by the image processing apparatus 10 will be described with reference to FIG. 3. In this embodiment, the image display processing method shown in FIG. 3 is realized when the CPU 20 reads and executes an image display processing program stored in the hard disk drive 26. Moreover, this image display processing is performed for every still image, when the still images displayed on the liquid crystal display unit 40 are specified by instructions from a user or by the program manipulation of the CPU 20.

As shown in FIG. 3, the image processing apparatus 10 displays the specified image on the liquid crystal display unit 40 (Step S100). In greater detail, the image processing apparatus 10 reads specified image data from the hard disk drive 26, develops image display data on the basis of the read image data, and stores the image display data in the first image storage region 60 or the second image storage region 70 in the memory 22. Furthermore, the liquid crystal display drive circuit 30 displays an image on the liquid crystal display unit 40 by carrying out drive control of the liquid crystal display 42 on the basis of the developed image display data. Thereby, for example, the image as shown in FIG. 4 is displayed on the liquid crystal display unit 40. It is known from the above description that information about a plurality of pixels for forming an image is included in the image display data. Moreover, the information about each pixel generally includes display gradations of three colors, red, green, and blue.

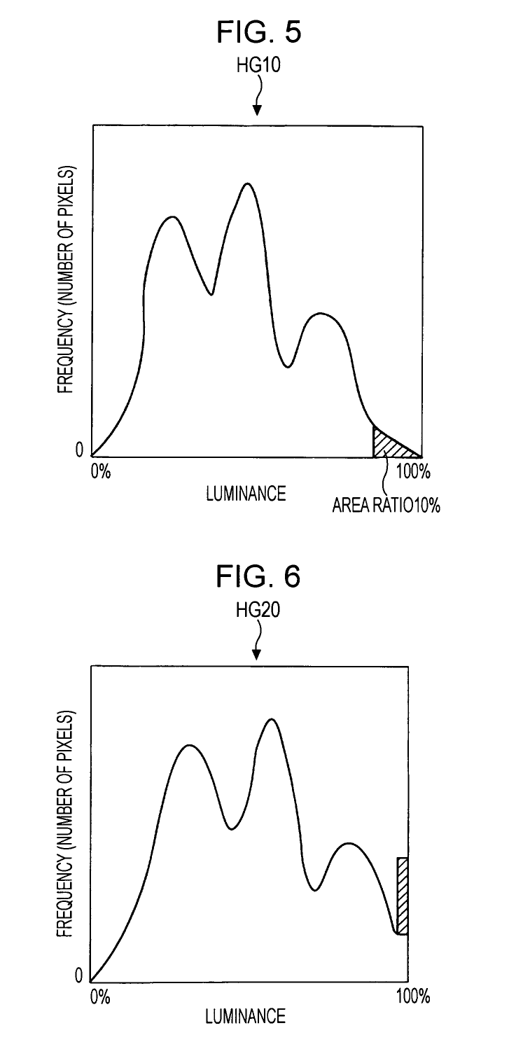

Next, the image processing apparatus 10 generates a histogram of the displayed image (Step S110). FIG. 5 is a view showing an example of histogram HG10 generated at Step S110. In the histogram HG10 shown in FIG. 5, a horizontal axis expresses luminance, and the luminance is expressed by 0% to 100% of values in this embodiment. 0% is a value representing the darkest luminance and 100% is a value representing the brightest luminance. A vertical axis expresses the frequency of the luminance, i.e., the number of pixels. The histogram shows that a larger frequency means a larger number of pixels relating to the same luminance value. When the frequency is set to 0, there is no pixel relating to the corresponding luminance.

At Step S110, the image processing apparatus 10 reads the display image data developed in the memory 22, and generates the histogram HG10 on the basis of the display image data. That is, the luminance of each pixel is acquired and counted on the basis of the display image data stored in the first image storage region 60 or the second image storage region 70 of the memory 22. Then, the histogram HG10 is generated on the basis of the count result. When each pixel in display image data is expressed by gradations of three colors, red, green, and blue, the luminance is computed on the basis of the display gradation of each color.

In addition, the luminance of each pixel may be computed on the basis of the image data read from the hard disk drive 26 at this Step S110. When computing the luminance on the basis of the image data, in the case in which the luminance information for every pixel is included in the format of image data, what is necessary is just to ask for the luminance of each pixel using the luminance information.

The count of the luminance is performed in the following manner. That is, when the luminance of a certain pixel is acquired, and the luminance of the pixel is 50%, the number one is added to the frequency of 50% of luminance. The histogram HG10 can be created if this count processing is performed for all the pixels. However, when there are too many pixels, the pixels whose luminance is acquired and counted may be sampled. For example, the luminance may be acquired at a rate of one pixel per two pixels. Further, the luminance may be acquired at a rate of one pixel per four pixels which form a square area.

Next, the image processing apparatus 10 determines a cutoff luminance value to cut off (Step S120). That is, the cutoff luminance value is determined on the basis of the histogram HG10 generated at Step S110. In this embodiment, the cutoff luminance value is determined in a manner such that the total area of the whole luminance distribution is obtained by integrating with the histogram HG10 and the area corresponding to 10% with high luminance among the area of the whole luminance distribution may be the target of a cutoff domain. That is, the cutoff luminance value which becomes the minimum luminance of the cutoff domain is set up so that the cutoff domain may become 10% of the total area of the whole luminance distribution.

However, it is also preferable that the cutoff luminance value may be preliminarily defined as a fixed value like 90% or 95%. Moreover, the area ratio to cut off may be changed according to the setting mode of the image processing apparatus 10. For example, the cutoff luminance value may be determined such that the area corresponding to 30% with the high luminance in the total area of the whole luminance distribution will be the target of the cutoff domain when the image processing apparatus 10 is set as the power save mode. On the other hand, when the image processing apparatus 10 is set as the highly fine display mode, the cutoff luminance value will be determined such that only the area corresponding to 5% with the high luminance in the total area of the whole luminance distribution may be the target of the cutoff domain.

Next, the image processing apparatus 10 changes the luminance of each pixel of the display image data (Step S130). That is, on the whole, the image processing apparatus 10 raises the luminance of each pixel of the display image data stored in the memory 22 on the basis of the cutoff luminance value determined at Step S120. With this embodiment, for example, the change of the luminance is carried such that the luminance after change equals to the calculation result of a formula “luminance before change×100%/the cutoff luminance value.” However, the maximum luminance after change is 100%. At this time, if the calculation result exceeds 100% with respect to certain pixels, the luminance of such pixels after change is determined as 100%.

For example, if the cutoff luminance value determined at Step S120 were 90%, as for the pixels whose present luminance is 90%, the luminance of the pixels will be changed to 100% by the processing of Step S130. Moreover, as for the pixels whose present luminance is 10%, the luminance of the pixels is changed to 11.1%. However, as for all the pixels whose present luminance is in the range from 90% to 100%, the luminance of each of such pixels may be converged to 100%.

Supposing that the histogram of the display image data after the luminance change is generated, it comes to be shown in FIG. 6, for example. That is, as for all the pixels whose original luminance is 90% or more in the histogram HG10, the luminance of each of the pixels is altogether converged to 100% in a histogram HG20 after the luminance change. Moreover, as for the pixels whose original luminance is about 0% or more and less than 90%, the luminance is distributed in the range from 0% to 100%.

The display image data consisting of the luminance after change is stored in an image storage region other than the image storage region where the display image data before change is stored. That is, when the display image data before change is stored in the first image storage region 60, the display image data after change is stored in the second image storage region 70. Moreover, when the display image data before change is stored in the second image storage region 70, the display image data after change is stored in the first image storage region 60. This changes the image to be displayed on the liquid crystal display unit 40 in the next frame period to the image after the luminance change.

Next, the image processing apparatus 10 changes the light quantity of the backlight 44 on the basis of the cutoff luminance value determined at Step S120 (Step S140). Namely, since a domain corresponding to 10% with the high luminance of the whole area is cut off when the cutoff luminance value is determined to 90% at Step S120, the image processing apparatus 10 decreases the light quantity of the backlight 44 by 10%. Specifically, the backlight control circuit 32 of the image processing apparatus 10 lowers the voltage of the backlight 44 by 10%. However, in greater detail, when the relationship between the light quantity of the backlight 44 and the voltage of the backlight 44 is nonlinear and a proper effect cannot be acquired only by dropping the voltage simply at a rate of the cut off luminance value, the rate for dropping the voltage of the backlight 44 may be determined using a certain conversion formula.

Moreover, suppose that the light quantity will be changed at step S140 of this embodiment on the basis a user setup of the light quantity of the backlight 44 of the image processing apparatus 10. For example, when the user has set the setup of the backlight 44 of the image processing apparatus 10 as 100% of light quantity, the light quantity is set up 10% low from 100% of the preset value of the backlight 44, and the light quantity is changed to 90%. Moreover, when the user has set the setup of the backlight 44 of the image processing apparatus 10 as 50% of light quantity, the light quantity is set up low 10% from 50% of the preset value of the backlight 44, and the light quantity is changed to 45%.

The image display processing according to this embodiment is terminated by this step S140.

As mentioned above, in the image processing apparatus 10 according to this embodiment, the light quantity of the backlight 44 is lowered while the luminance of each pixel of the display image data is raised. Accordingly, it is possible to reduce the electric power consumed by the backlight 44 without deteriorating the user's impression with respect to the display image greatly. That is, the histogram HG10 of the display image is generated, the setting of the luminance of the pixels whose luminance is beyond the cutoff luminance value in the histogram HG10 is changed to 100%, and the setting of the luminance of the pixels whose luminance is in the range from 0% to the cutoff luminance value in the histogram HG10 is extended from 0% to 100%. Thus, the luminance distribution of the histogram is kept from changing a lot. For this reason, even if the light quantity of the backlight 44 is dropped that much, it can avoid changing a lot the impression of the image displayed on the liquid crystal display unit 40.

Moreover, since the image display processing according to this embodiment is realized by software executed by the CPU 20, the image display processing according to this embodiment can reduce the manufacturing cost compared with the image display processing realized by hardware.

In addition, the invention is not limited to the embodiment, but can change into versatility. For example, although the explain about the invention relates to the case in which the image processing apparatus 10 displays an image on the liquid crystal display unit 40 on the basis of the image data of a still image, the invention can be applied also to the case in which an image is displayed on the liquid crystal display unit 40 on the basis of the image data of a moving picture.

Moreover, although the embodiment explained above relates to the case in which the image display unit is the liquid crystal display unit 40, the invention also can be applied to other types of image display units if the image display units employ a backlight whose light quantity can be adjusted.

Moreover, although the image before changing the light quantity of the backlight is displayed at step S100 in this embodiment, it can avoid displaying the image before changing the light quantity of the backlight in the case in which an image changes and the display of the following image is slightly overdue but such overdue does not matter. However, even in the case of displaying the image before changing the light quantity of the backlight like this embodiment, since time a period of one frame is 33 ms, it is usually thought that change of the displayed image cannot be recognized with the naked eye.

What is claimed is:

1. An image processing apparatus comprising:
a first display image data generation unit which acquires image data and generates first display image data including information about a plurality of pixels;
a histogram generation unit which generates a histogram showing luminance distribution of the pixels contained in the first display image data;
a second display image data generation unit which generates second display image data by taking a domain corresponding to a predetermined percent with high luminance among the entire luminance distribution area as a cutoff domain in the histogram generated by the histogram generation unit, setting up the luminance of the pixels in the cutoff domain to 100%, and changing the luminance of the pixels whose luminance is in a range from 0% to a cutoff luminance value which is a minimum luminance of the pixels in the cutoff domain to be 0 to 100% while maintaining the luminance distribution;
an image display unit which has a backlight and displays an image on the basis of the second display image data; and
a backlight setting change unit which changes a setup of the light quantity of the backlight on the basis of the cutoff luminance value.

2. The image processing apparatus according to claim 1, wherein an image based on the first display image data is displayed on the image display unit.

3. The image processing apparatus according to claim 1, wherein the histogram generation unit generates the histogram of the pixels contained in the first display image data so that a brightest luminance and a darkest luminance are set up to 100% and 0%, respectively.

4. The image processing apparatus according to claim 1, wherein the second display image data generation unit changes the luminance of each of the pixels whose luminance is in a range from 0% to the cutoff luminance value to a value calculated by a formula: a luminance×100%/the cutoff luminance value.

5. The image processing apparatus according to claim 4, wherein the backlight setting change unit changes the setup of the light quantity of the backlight so as to be decreased from a preset value which is set as the light quantity of the backlight by a value corresponding to (100%−the cutoff luminance value).

6. The image processing apparatus according to claim 1, wherein the image data is image data of a still image.

7. A controlling method of an image processing apparatus, comprising:
generating a first display image data including information about a plurality of pixels by acquiring image data;
generating a histogram showing luminance distribution of the pixels contained in the first display image data;
generating a second display image data by taking a domain corresponding to a predetermined percent with high luminance among the entire luminance distribution area as a cutoff domain in the generated histogram, setting up the luminance of the pixels in the cutoff domain to 100%, and changing the luminance of the pixels whose luminance is in a range from 0% to a cutoff luminance value which is a minimum luminance of the pixels in the cutoff domain to be 0 to 100% while maintaining the luminance distribution;
displaying an image based on the second display image data on an image display unit having a backlight; and
changing a setup of the light quantity of the backlight on the basis of the cutoff luminance value.
